(19) United States
(12) Patent Application Publication
(10) Pub. No.: US 2019/0361651 A1
(43) Pub. Date: Nov. 28, 2019

(54) IMAGE PROCESSING SYSTEM AND IMAGE FORMING APPARATUS

(71) Applicant: TOSHIBA TEC KABUSHIKI KAISHA, Tokyo (JP)

(72) Inventors: Mei Yeen Wang, Singapore (SG); Noriyuki Watanabe, Mishima Shizuoka (JP)

(21) Appl. No.: 16/414,837

(22) Filed: May 17, 2019

(30) Foreign Application Priority Data
May 25, 2018 (JP) 2018-100201

(51) Int. Cl. G06F 3/12

(52) U.S. Cl. CPC G06F 3/1261; G06F 3/1296; G06K 15/028; G06F 3/1234; G06F 3/1285; G06F 3/121

(57) ABSTRACT

In accordance with an embodiment, an image processing system comprises a plurality of information processing apparatuses, a plurality of image forming apparatuses and a server connected with each other via a network. The sever includes a substitute list transmission section configured to transmit a list of substitute image forming apparatuses capable of executing an image forming job to the information processing apparatus transmitting the image forming job if an image forming apparatus receiving the image forming job from the information processing apparatus cannot execute the image forming job.

### CROSS-REFERENCE TO RELATED APPLICATION

This application is based upon and claims the benefit of priority from Japanese Patent Application No. 2018-100201, filed on May 25, 2018, the entire contents of which are incorporated herein by reference.

### FIELD

Embodiments described herein relate generally to an image processing system and an image forming apparatus.

### BACKGROUND

A POS (Point of Sales) system for managing a retail store such as a supermarket includes a plurality of POS terminals connected to a network. For example, the POS terminal is arranged at a register counter, and is used to perform registration and checkout on a commodity that a customer desires to purchase. The POS terminal is connected to a POS printer via, for example, a USB (Universal Serial Bus) cable. The POS printer issues a receipt for the commodity after checkout.

At the time of issuing the receipt, the POS terminal transmits a printing job to the POS printer. If the POS printer is in the normal condition, the POS printer executes the printing job and issues the receipt. However, if the POS printer is in an abnormal condition, for example, a sheet jam or a system error occurs, the receipt cannot be issued until the problem is resolved. In this case, not only a customer waiting for the issuance of the receipt but also the following customers waiting for checkout need to wait.

Thus, the POS terminal and the POS printer are connected with each other in a one-to-one manner. Therefore, the issuance of the receipt is difficult to resume if a problem that the POS printer cannot execute the printing job occurs.

### DESCRIPTION OF THE DRAWINGS

FIG. 1 is a diagram illustrating an overall configuration of a POS system provided with an image processing system according to a first embodiment;

FIG. 2 is a block diagram of a POS terminal according to the first embodiment;

FIG. 3 is a block diagram of a POS server according to the first embodiment;

FIG. 4 is a perspective view illustrating an external appearance of the POS printer according to the first embodiment;

FIG. 5 is a cross-sectional view of the POS printer as viewed from the side surface side according to the first embodiment;

FIG. 6 is a block diagram of the POS printer according to the first embodiment;

FIG. 7 is a flowchart depicting a printing recovery processing performed by the image processing system according to the first embodiment;

FIG. 8 is a diagram illustrating an example of a display screen on the POS terminal displayed when the printing recovery processing is performed;

FIG. 9 is a block diagram of a POS printer according to a second embodiment;

FIG. 10 is a flowchart depicting a printing recovery processing performed by an image processing system according to the second embodiment;

FIG. 11 is a diagram illustrating an operation performed on the POS printer when the printing recovery processing is performed;

FIG. 12 is a flowchart depicting a printing recovery processing performed by an image processing system according to a third embodiment; and

FIG. 13 is a diagram illustrating an example of information included in a POS printer DB of the POS server.

### DETAILED DESCRIPTION

In accordance with an embodiment, an image processing system comprises a plurality of information processing apparatuses, a plurality of image forming apparatuses and a server connected with each other via a network. The sever includes a substitute list transmission section configured to transmit a list of substitute image forming apparatuses capable of executing an image forming job to the information processing apparatus transmitting the image forming job if an image forming apparatus receiving the image forming job from the information processing apparatus cannot execute the image forming job.

Hereinafter, an image processing system and an image forming apparatus according to an embodiment are described in detail with reference to the accompanying drawings. In each drawing, the same components are denoted with the same reference numerals.

### First Embodiment

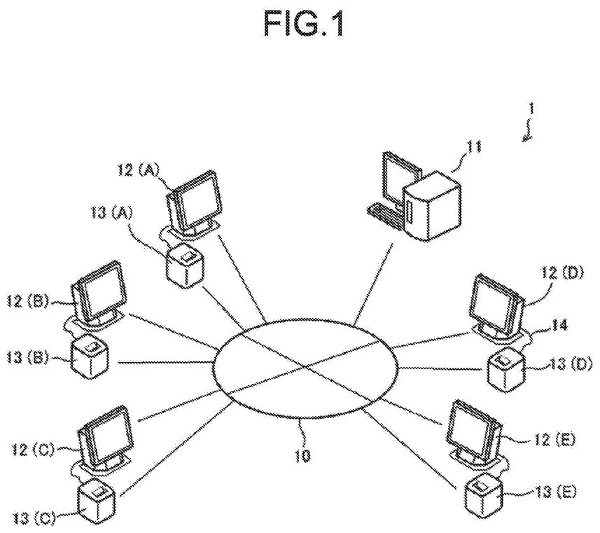

FIG. 1 is a diagram illustrating an overall configuration of a POS system 1 which manages a retail store such as a supermarket. An image processing system of the first embodiment is incorporated into the POS system 1. The POS system 1 includes a POS server 11 connected to a network 10. The POS server 11 is, for example, a cloud server or a local server. The POS server 11 collectively manages, for example, information relating to commodities sold in the retail store. The POS system 1 includes a plurality of POS terminals 12 connected to the network 10. The POS terminal 12 is, for example, a terminal-type POS terminal 12 installed at a register counter. The POS terminal 12 sequentially registers commodities a customer desires to purchase and performs settlement on a purchase amount after registration of all the commodities according to an operation performed by a store clerk. Alternatively, a customer himself/herself may perform registration and checkout on the commodities in a self-service manner. Although POS terminals 12(A to E) and POS printers 13(A to E) are shown in FIG. 1, the number of POS terminals 12 and the number of POS printers 13 are not limited.

The POS printer 13 is an example of an image forming apparatus according to the embodiment. The POS printer 13 prints a receipt on which details of a purchased commodity are recorded. The POS printer 13 is connected to the POS terminal 12 via a communication cable 14 such as a USB cable, for example. Alternatively, the POS terminal 12 and the POS printer 13 may be integrally formed by enabling a main body of the POS terminal 12 to have a printer function. Specifically, the POS terminal 12 and the POS printer 13 are connected to each other in a one-to-one manner. When the POS terminal 12 issues a receipt, the POS terminal 12 transmits a printing job to the POS printer 13 paired therewith via the communication cable 14. The POS printer 13 prints a receipt based on the received printing job.

The POS printer 13 is further connected to the network 10. The POS printer 13 communicates with the POS server 11 via the network 10. The communication between the POS printer 13 and the POS server 11 via the network 10 is used in a printing job recovery processing described below in detail.

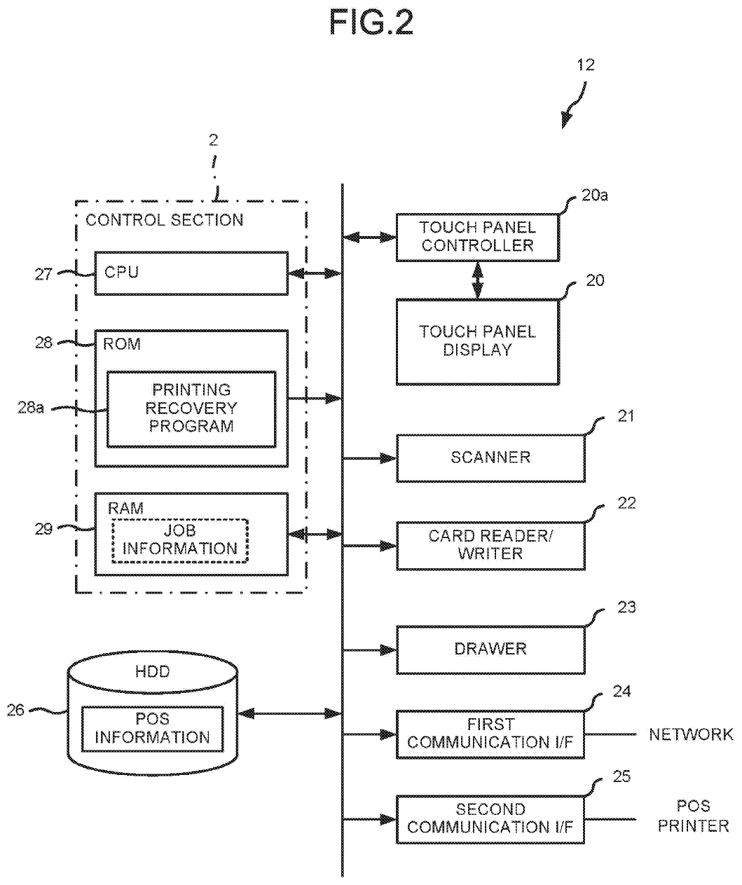

FIG. 2 is a block diagram of the POS terminal 12. The POS terminal 12 is an example of an information processing apparatus. The POS terminal 12 includes a control section 2, a touch panel display 20, a touch panel controller 20a, a scanner 21, a card reader/writer 22, a drawer 23, a first communication interface 24, a second communication interface 25 and a storage device 26. The components are connected to each other, for example, through a system bus.

The control section 2 comprises a CPU (Central Processing Unit) 27, a ROM (Read Only Memory) 28 and a RAM (Random Access Memory) 29. The CPU 27, the ROM 28 and the RAM 29 are arranged on, for example, a circuit board. The CPU 27 controls the overall operation of the POS terminal 12. The ROM 28 stores various programs and data. The RAM 29 stores various programs and data, and can rewrite the data. The storage device 26 is, for example, an HDD (Hard Disk Drive). The storage device 26 stores various kinds of POS information necessary for performing registration and checkout on a commodity.

The programs stored in the ROM 28 include an operating system and application programs for performing the functions of the POS terminal 12. The CPU 27 reads out the application program stored in the ROM 28 to execute it. The application programs include various programs for executing a series of POS services, such as registration and checkout of a commodity, generation of a printing job relating to a receipt, and transmission of the printing job to the POS printer 13. The application programs further include a printing recovery program 28a performed when the POS printer 13 cannot execute the printing job.

The touch panel display 20 has functions of both a display section and an operation section of the POS terminal 12. The touch panel display 20 is, for example, a liquid crystal display or an organic EL (Electro-Luminescence) display provided with a touch sensor. The touch panel controller 20a controls an image display operation of the touch panel display 20. The touch panel controller 20a transmits information relating to a touch operation on the touch panel display 20 performed by a user such as a store clerk to the control section 2.

The scanner 21 scans a one-dimensional or two-dimensional barcode attached to a commodity the customer desires to purchase. The barcode is generated by encoding information such as a commodity number. The control section 2 reads out information such as a type and a price of the commodity from commodity information stored in the POS server 11 based on the information such as the commodity number scanned by the scanner 21. The card reader/writer 22 reads out information recorded on a card presented by the customer at the time of checkout, or rewrites the information on the card. The card is, for example, a traffic or distribution IC (Integrated Circuit) card, a point card, a credit card, or the like. The drawer 23 stores cash and deposits cash deposited by the customer at the time of checkout. If there is a change, the change is dispensed. Deposit and dispense are automatically performed in the case of an automatic drawer 23, or manually performed by a store clerk in the case of a manual drawer 23.

The first communication interface 24 is connected to the network 10. The first communication interface 24 is connected to a communication device such as a router over the network 10 via a communication cable such as a LAN (Local Area Network) cable. The control section 2 transmits and receives data to and from the POS server 11 and the POS printer 13 via the first communication interface 24 and the network 10. The first communication interface 24 is an example of a job transfer section that transmits a printing job described below to the POS server 11.

The second communication interface 25 is connected to the POS printer 13. The second communication interface 25 is connected to the POS printer 13 via the communication cable 14 such as the USB cable. The control section 2 transmits and receives data to and from the POS printer 13 via the second communication interface 25. However, the connection with the POS printer 13 may be wireless connection instead of wired connection.

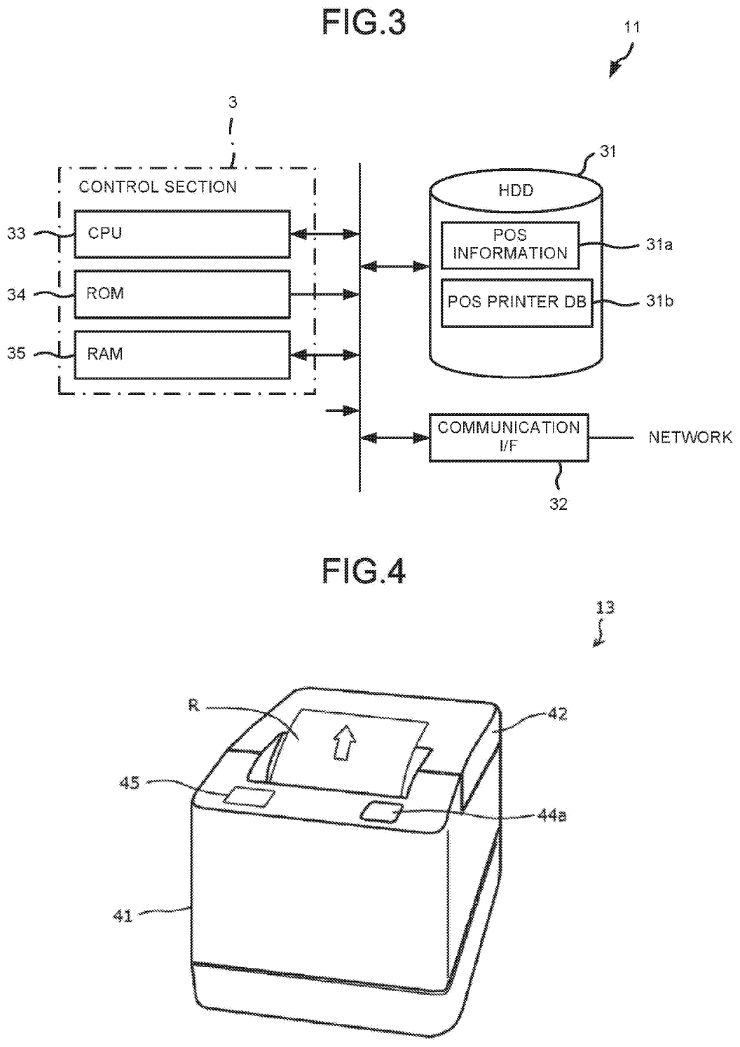

FIG. 3 is a block diagram of the POS server 11. The POS server 11 is an example of a server. The POS server 11 includes a control section 3, a storage device 31 and a communication interface 32. The respective components are connected to each other, for example, through a system bus. The control section 3 includes a CPU 33, a ROM 34 and a RAM 35. The CPU 33, the ROM 34 and the RAM 35 are arranged on, for example, a circuit board. The CPU 33 controls the overall operation of the POS server 11. The ROM 34 stores various programs and data. The RAM 35 stores various programs and data and can rewrite various kinds of data.

The programs stored in the ROM 34 include an operating system and application programs for performing the functions of the POS server 11. The CPU 33 reads out the application program stored in the ROM 34 to execute it. The application programs include various programs for managing commodities sold in the retail store. The application programs further include a program performed in response to a request from the POS terminal 12 and/or the POS printer 13 when the POS printer 13 cannot execute the printing job.

The storage device 31 is, for example, an HDD. The storage device 31 stores POS information 31a for collectively managing commodities sold in the retail store. The storage device 31 further stores a POS printer DB (database) 31b. The POS printer DB 31b is a database of the POS printer 13 connected to the network 10. The POS printer DB 31b stores information necessary for communication via the network 10, such as a printer ID, a manufacturer, and an IP (Internet Protocol) address of the printer. The POS printer DB 31b may also store a printer driver as necessary.

The communication interface 32 is connected to the network 10. The communication interface 32 is connected to a communication device such as a router over the network 10 via the communication cable such as the LAN cable. The control section 3 transmits and receives data to and from the POS terminal 12 and the POS printer 13 via the communication interface 32 and the network 10. The communication interface 32 is an example of a substitute list transmission section that transmits a list of substitute POS printers 13 described below.

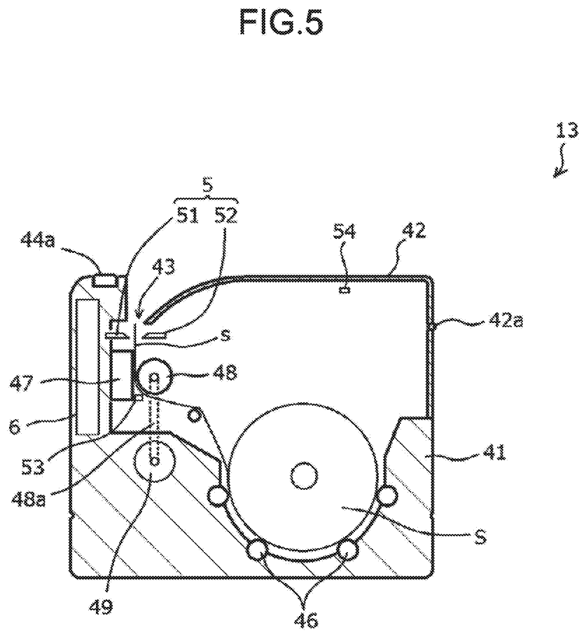

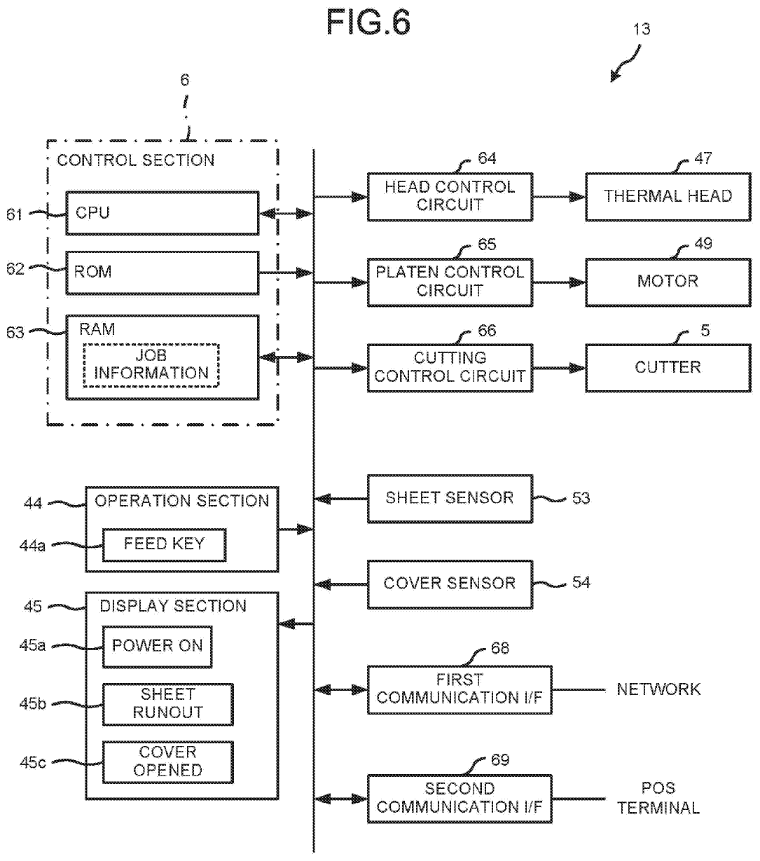

FIG. 4 is a perspective view illustrating an external appearance of the POS printer 13. FIG. 5 is a cross-sectional view of the POS printer 13 as viewed from the side surface side thereof. FIG. 6 is a block diagram of the POS printer 13.

The POS printer 13 is a thermal printer, for example. As shown in FIG. 4 and FIG. 5 in particular, in the POS printer 13, an exterior body is formed by a main body 41 and a cover 42. In the POS printer 13, a discharge port 43 for discharging a printed receipt R is arranged at the top of the main body 41. Further, in the POS printer 13, a FEED key 44a which is an operation section and a display section 45 are arranged at the top of the main body 41. The cover 42 is openable and closable in a vertical direction with a horizontal shaft 42a provided on a back surface of the main body 41 as a support shaft. The cover 42 is opened and closed, for example, when a roll-shaped sheet S is placed in the main body 41. The roll-shaped sheet S is an example of a printing medium on which the receipt R is printed. The roll-shaped sheet S is, for example, a thermal paper.

The roll-shaped sheet S is rotatably supported by a plurality of supporting rollers 46. The plurality of supporting rollers 46 is arranged in parallel with a central axis of the roll-shaped sheet S, respectively. A front end of the sheet S drawn out from the roll is conveyed towards the discharge port 43. A thermal head 47 and a platen roller 48 are arranged in the middle of a conveyance path of the sheet S. The thermal head 47 and the platen roller 48 constitute an example of an image forming section. The thermal head 47 is a print head in which heat generation elements for forming dots are arranged in a line, for example. The thermal head 47 is arranged in such a manner that a portion where the heat generation elements are arranged faces the platen roller 48 across the sheet S, and is biased towards the platen roller 48 by a biasing device (not shown) such as a spring.

In the platen roller 48, a portion in contact with the sheet S is made of a resin such as rubber. The platen roller 48 is connected to a motor 49 which is an example of a drive device via a power transmission device 48a such as a gear or a rotation belt. The motor 49 is, for example, a stepping motor. The platen roller 48 is rotated by a driving force from the motor 49. The thermal head 47 and the platen roller 48 synchronize a printing operation and a conveyance operation to perform printing on the sheet S.

A cutter 5 for cutting the sheet S is arranged between the discharge port 43 and a printing section (sheet pinching section) formed by the thermal head 47 and the platen roller 48. The cutter 5 includes a fixed blade 51 and a movable blade 52. The movable blade 52 is movable forward and backward with respect to the fixed blade 51. The cutter 51 cuts a rear end of the printed sheet S by moving the movable blade 52 forward and backward.

A sheet sensor 53 for detecting the presence of the sheet S is arranged, for example, in front of the printing section (sheet pinching section) formed by the thermal head 47 and the platen roller 48. A cover sensor 54 for detecting the opening and closing of the cover 42 is arranged, for example, in the vicinity of the cover 42. The sheet sensor 53 and the cover sensor 54 are, for example, optical sensors.

A control section 6 for controlling the overall operation of the POS printer 13 is arranged in the main body 41. As shown in the block diagram in FIG. 6, the control section 6 includes a CPU 61, a ROM 62 and a RAM 63. The CPU 61, the ROM 62 and the RAM 63 are arranged on a circuit board, for example. The CPU 61 controls the overall operation of the POS printer 13. The ROM 62 stores various programs and data. The RAM 63 stores various programs and data, and can rewrite data. The data stored in the RAM 63 includes information relating to a printing job received from the POS terminal 12. The RAM 63 is preferably nonvolatile.

A head control circuit 64 controls the printing operation of the thermal head 47. The control section 6 generates control signals such as dot arrangement information of an image to be printed, a latch signal, a strobe signal and the like based on the information relating to the printing job received from the POS terminal 12, and then transmits the control signals to the head control circuit 64. A platen control circuit 65 controls operations of the motor 49 such as start and stop. The control section 6 transmits a control signal to the platen control circuit 65 to rotate the platen roller 48 in synchronization with the printing operation by the thermal head 47. A cutting control circuit 66 controls the operation of the cutter 5. The control section 6 transmits a control signal to the cutting control circuit 66 to cut the rear end of the sheet S after the printing is terminated.

The sheet sensor 53 detects whether or not there is a sheet S in front of the printing section (sheet pinching section) formed by the thermal head 47 and the platen roller 48. The control section 6 executes the printing operation if the sheet sensor 53 detects the sheet S, or transmits a signal “the sheet runs out” to the display section 45 without performing the printing operation if no sheet S is detected. The cover sensor 54 detects whether or not the cover 42 is closed. The control section 6 executes the printing operation if the cover sensor 54 detects that the cover is closed, or transmits a signal “the cover is open” to the display section 45 without performing the printing operation if the cover sensor 54 detects that the cover is open.

An operation section 44 for operating the POS printer 13 includes the FEED key 44a. When a user presses the FEED key 44a, the control section 6 transmits a control signal to the platen control circuit 65 to rotate the platen roller 48 to feed the sheet S towards the discharge port 43. The display section 45 displays various statuses of the POS printer 13. The display section 45 includes an indicator lamp 45a for displaying a power ON state, an indicator lamp 45b for displaying that the sheet runs out, and an indicator lamp 45c for displaying that the cover is open. The display lamps 45a to 45c are, for example, LED (Light Emitting Diode) lamps.

A first communication interface 68 is connected to the network 10. The first communication interface 68 is connected with a communication device such as a router over the network 10 via the communication cable such as the LAN (Local Area Network) cable, for example. The control section 6 transmits and receives data to and from the POS server 11 via the network 10 and the first communication interface 68. The first communication interface 68 is an example of a job transfer section for transferring a later-described printing job to the POS terminal 11. The first communication interface 68 is also an example of a job reception section for receiving a later-described printing job from the POS terminal 11.

A second communication interface 69 is connected to the POS terminal 12. The second communication interface 69 is connected to the POS terminal 12 via the communication cable 14 such as the USB cable, for example. The control section 6 transmits and receives data to and from the POS terminal 12 via the second communication interface 69. However, the connection with the POS terminal 12 may be wireless connection rather than wired connection.

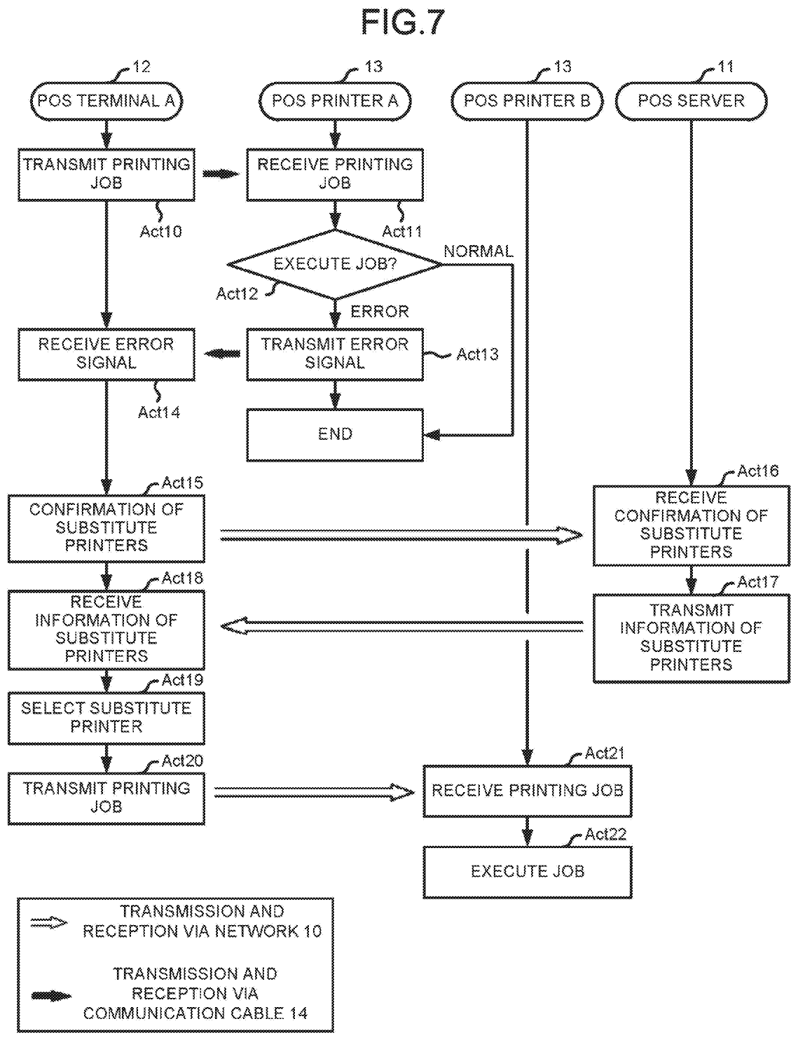

Next, the flow of the printing recovery processing performed by the POS system 1 when the POS printer 13 cannot execute the printing job is described with reference to FIG. 7. The following description is given for the flow of a recovery processing in which the substitute POS printer 13(B) paired with the POS terminal 12(B) executes printing among the POS printers 13 (B to E) when the POS printer 13 (A) paired with the POS terminal 12(A) cannot execute the printing job, as an example of the printing recovery processing.

The POS terminal 12(A) performs registration and checkout on a commodity the customer desires to purchase, for example, by the operation performed by the store clerk during the business hours of the retail store. The POS terminal 12(A) generates a printing job for issuing a receipt R after checkout, and transmits information of the generated printing job to the POS printer 13(A) paired therewith (Act 10). The POS printer 13(A) receiving the information relating to the printing job in Act 11 temporarily stores the information relating to the printing job in, for example, the RAM 63, and controls each control circuit to execute the printing job. However, if the printing job cannot be performed due to a problem such as jam of the sheet S or a system error (Act 12, error), the POS printer 13(A) generates an error signal and transmits it to the POS terminal 12(A) (Act 13). The case in which the printing job cannot be performed is not limited to the case in which the printing job cannot be performed thoroughly, and also includes the case in which the printing job cannot be completed due to a problem occurring during the execution of the printing job.

The POS terminal 12(A) receiving the error signal in Act 14 executes the printing recovery program 28a, and requests the POS server 11 for confirmation of the substitute printer (Act 15). The POS server 11 receiving the request for confirmation of the substitute printer in Act 16 confirms statuses of the POS printers 13(A to E) registered in the printer DB 31b, and creates a list of substitute POS printers 13 that can execute printing. The POS server 11 selects a POS printer 13 prepared to receive the printing job as the substitute printer. The POS printer 13 prepared to receive the printing job is, for example, a POS printer 13 that completes a startup operation or a POS printer 13 in an idle state or a sleep state. However, the POS printer 13 paired with the POS terminal 12 being in operation (i.e., being performed by a customer) may be excluded from candidates of the substitute printer to prevent confusion with the receipt R printed in response to a request from the paired POS terminal 12. The POS server 11 creates a list of substitute printers and transmits the list to the POS terminal 12(A) via the network 10 (Act 17).

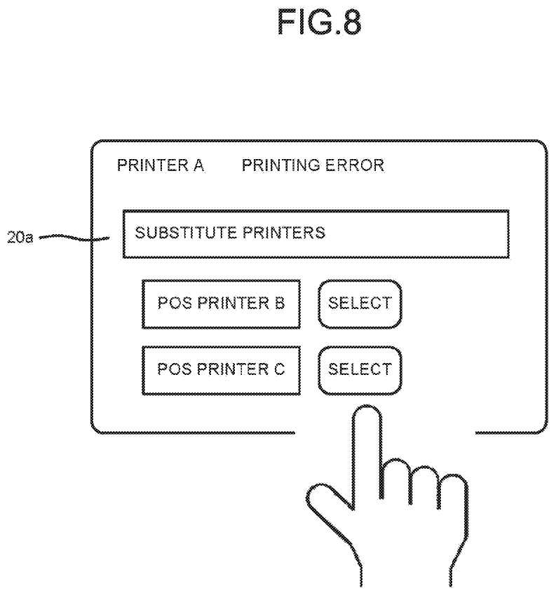

The POS terminal 12(A) receiving the list of substitute printers in Act 18 displays the list of substitute printers on the touch panel display 20, for example. FIG. 8 is an example of a display screen on the touch panel display 20. The store clerk who is operating the POS terminal 12(A) confirms the list of substitute printers displayed on the touch panel display 20, and then selects a substitute POS printer 13 to execute the printing job (Act 19). In this example, the POS printer 13(B) and the POS printer 13(C) are included in the list of substitute printers, and the POS printer 13(B) is selected. The POS terminal 12(A) transmits the same information as the information relating to the printing job transmitted to the POS printer 13(A) to the POS printer 13(B) which is the selected substitute printer via the network 10 (Act 20). If the communication setting is not made between the POS terminal 12(A) and the POS printer 13(B), the POS terminal 12(A) may transmit the information relating to the printing job to the POS server 11, and meanwhile request the transfer of the information relating to the printing job to the POS printer 13(B). The POS printer 13(B) receiving the information relating to the printing job in Act 21 temporarily stores the information relating to the printing job in, for example, the RAM 63, and controls each control circuit to perform the printing operation (Act 22). The store clerk who operates the POS terminal 12(A) takes the receipt R printed by the POS printer 13(B) and hands it over to the customer.

It is preferable to display a message indicating that the POS printer 13(B) executes the printing instead of the POS printer 13(A) on the touch panel display 20 of the POS terminal 12(B) paired with the substitute POS printer 13(B). In this way, it is possible to prevent the store clerk who operates the POS terminal 12(B) from taking a wrong receipt R, and further, the store clerk who operates the POS terminal 12(B) can previously know that the store clerk who operates the POS terminal 12(A) will come to pick up the receipt R.

According to the above embodiment, when the POS printer 13 cannot execute the printing job, the POS printers 13 capable of recovering the printing job are extracted from the POS printers 13 connected to the network 10, and the list of the extracted POS printers 13 is displayed on the touch panel display 20 of the POS terminal 12, and in this way, the printing job that cannot be performed by the POS printer 13 can be recovered quickly.

### Second Embodiment

Next, the POS system 1 incorporating an image processing system according to the second embodiment is described. The overall configuration of the POS system 1 is the same as that of the POS system 1 shown in FIG. 1. However, the POS system 1 of the second embodiment differs from the POS system 1 of the first embodiment in the operations of the POS terminal 12, the POS printer 13 and the POS server 11 in the printing recovery processing.

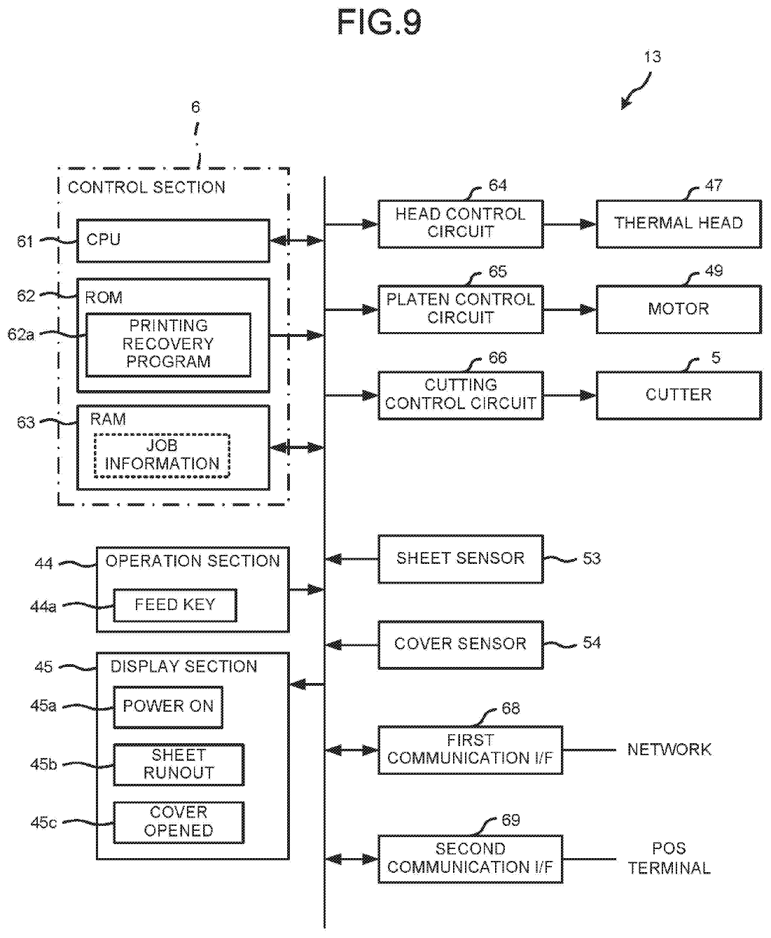

As shown in FIG. 9, the POS printer 13 of the second embodiment stores a printing recovery program 62a as an application program in, for example, the ROM 62. When a predetermined operation is performed on the operation section 44 by, for example, a store clerk, the control section 6 executes the printing recovery program 62a to execute a processing of requesting the POS server 11 to confirm whether the printing job that cannot be performed is stored. If the POS server 11 stores the printing job, the control section 6 receives the information relating to the printing job from the POS server 11 to control the POS printer 13 to execute the printing job or execute the printing job as a substitute printer.

The predetermined operation performed on the operation section 44 is, for example, an operation of pressing the FEED key 44a three times. Specifically, although the FEED key 44a is originally used for rotating the platen roller 48 to feed the sheet S towards the discharge port 43, it may also be used as a password key (recovery key) for recovering printing. Thus, there is an advantage that it is not necessary to change the hardware configuration merely by adding a printing recovery function using software to the POS printer 13. Of course, it is not necessary to use the FEED key 44a.

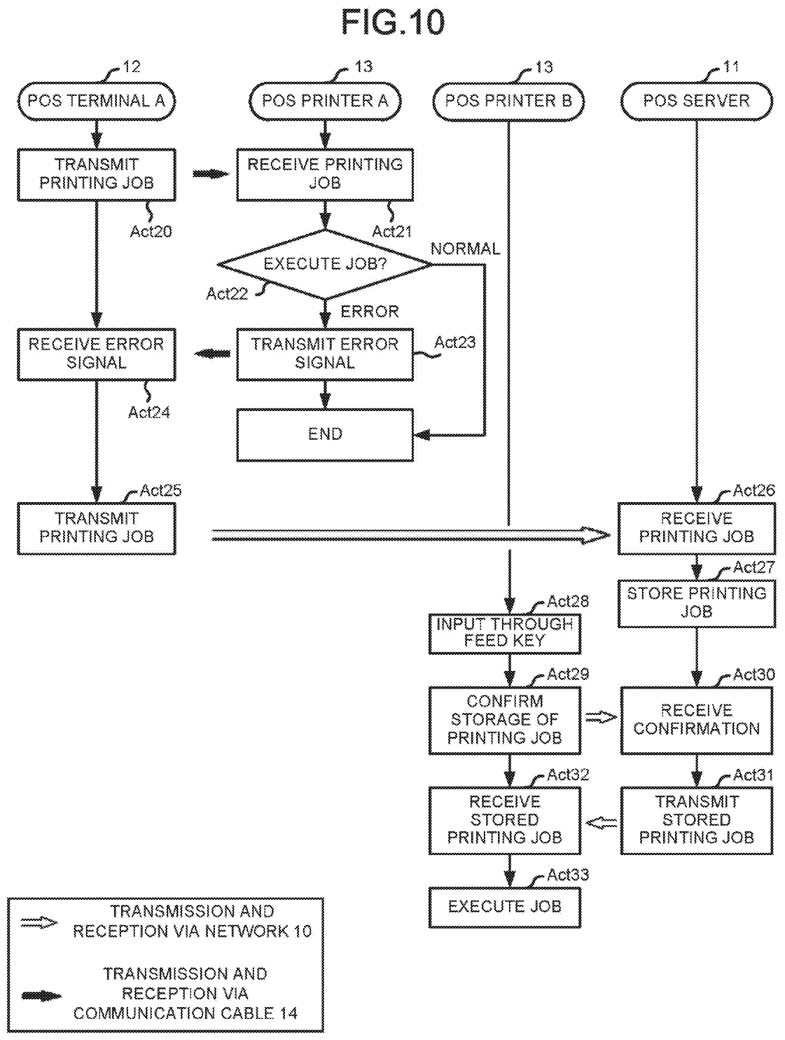

Next, the flow of the printing recovery processing performed by the POS system 1 when the POS printer 13 cannot execute the printing job is described with reference to FIG. 10. The following description is given for the flow of a recovery processing in which the substitute POS printer 13(B) paired with the POS terminal 12(B) executes the printing among the POS printers 13(B to E) when the POS printer 13(A) paired with the POS terminal 12(A) cannot execute the printing job, as an example of the printing recovery processing.

The POS terminal 12(A) performs registration and checkout on a commodity the customer desires to purchase, for example, by the operation performed by the store clerk during the business hours of the retail store. The POS terminal 12(A) generates a printing job for issuing a receipt R after checkout, and transmits information of the generated printing job to the POS printer 13(A) paired therewith (Act 20). The POS printer 13(A) receiving the information relating to the printing job temporarily stores the information relating to the printing job in, for example, the RAM 63, and controls each control circuit to execute the printing job. However, if the printing job cannot be performed due to a problem such as jam of the sheet S or a system error (Act 22, error), the POS printer 13(A) generates an error signal and transmits it to the POS terminal 12(A) (Act 23).

The POS terminal 12(A) receiving the error signal from the POS printer 13(A) in Act 24 transmits the same information as the information relating to the printing job transmitted to the POS printer 13(A) to the POS server 11 via the network 10 (Act 25). Specifically, when the POS printer 13(A) paired with the POS terminal 12(A) cannot execute the printing job, the POS terminal 12(A) executes a processing of transmitting the information relating to the printing job to the POS server 11 by executing the printing recovery program 28a.

The POS server 11 receives the information relating to the printing job from the POS terminal 12(A) (Act 26), and stores the information in, for example, the RAM 35 (Act 27). The POS server 11 sets, for example, the RAM 35 as a storage area dedicated for printing recovery. The storage area may be the storage device 31.

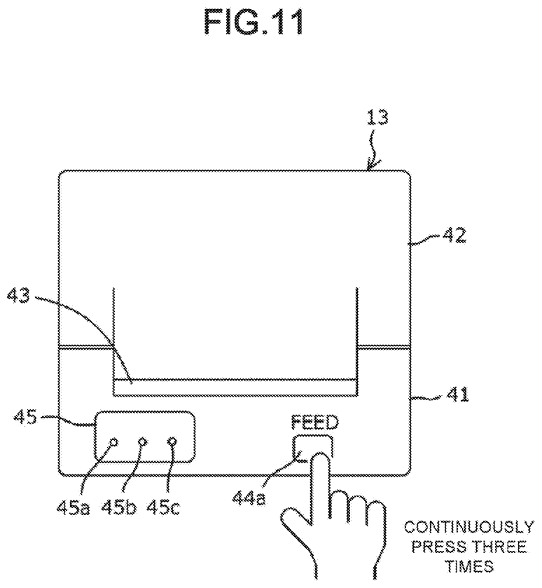

The store clerk who operates the POS terminal 12(A) moves to the POS printer 13(B). Then, as schematically shown in FIG. 11, the store clerk presses the FEED key 44a of the POS printer 13(B) three times. Specifically, a predetermined operation set for printing recovery is performed (Act 28). The POS printer 13(B) executes the printing recovery program 62a if the FEED key 44a is pressed three times, and requests the POS server 11 to confirm whether the printing job is stored (Act 29).

In response to the request from the POS printer 13(B), the POS server 11 confirms, for example, whether or not the printing job is stored in the RAM 35 (Act 30). If the printing job is stored, the POS server 11 transmits the information relating to the printing job to the POS printer 13(B) that has transmitted the request (Act 31). In this example, since the printing job transmitted by the POS terminal 12(A) is stored, the POS server 11 transmits the information relating to the printing job to the POS printer 13(B). On the other hand, if the printing job is not stored, the POS server 11 may not respond in particular.

The POS printer 13(B) receiving the information relating to the printing job in Act 32 temporarily stores the information relating to the printing job in, for example, the RAM 63, and controls each control circuit to perform the printing operation (Act 33). The store clerk who operates the POS terminal 12(A) hands the receipt R printed by the POS printer 13(B) over to the customer.

### Third Embodiment

Next, the POS system 1 incorporating an image processing system according to the third embodiment is described. The overall configuration of the POS system 1 is the same as that of the POS system 1 shown in FIG. 1. Furthermore, the POS system 1 of the third embodiment executes the same printing recovery processing as that performed by the POS system 1 of the second embodiment except that the POS printer 13 rather than the POS terminal 12 transmits the information relating to the printing job that cannot be performed to the POS server 11.

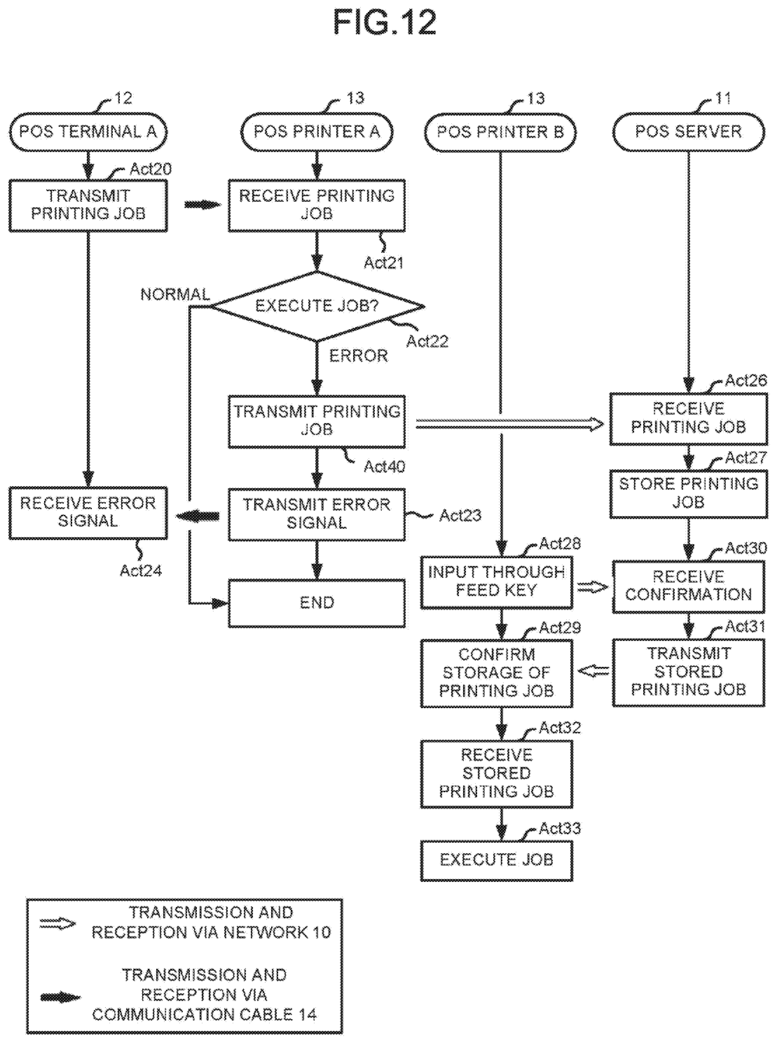

Accordingly, the flow of the printing recovery processing performed by the POS system 1 of the third embodiment is described below with reference to FIG. 12, and the same processing as that in the printing recovery processing performed by the POS system 1 of the second embodiment is denoted with the same reference numerals, and the description thereof is omitted.

The POS terminal 12(A) transmits the information relating to the printing job to the POS printer 13(A) (Act 20). The POS printer 13(A) receiving the information relating to the printing job in Act 21 temporarily stores the information relating to the printing job in, for example, the RAM 63, and controls each control circuit to execute the printing job. However, if the printing job cannot be performed due to a problem (Act 22, error), the POS printer 13(A) transmits the information relating to the printing job to the POS server 11 via the network 10 (Act 40). On the other hand, the POS printer 13(A) transmits an error signal to the POS terminal 12(A) (Acts 23 and 24). The POS server 11 stores the received information relating to the printing job (Acts 26 and 27).

If the store clerk performs the predetermined operation set for printing recovery on the operation section of the POS printer 13(B) (Act 28), the POS printer 13(B) requests the POS server 11 to confirm whether the printing job is stored (Act 29). The POS server 11 transmits the information relating to the stored printing job to the POS printer 13(B) (Acts 30 and 31). The POS printer 13(B) receiving the information relating to the printing job executes the printing job to print the receipt R (Acts 32 and 33).

The POS system 1 of either the second embodiment or the third embodiment stores the printing job in the POS server 11 when the POS printer 13 cannot execute the printing job. Then, if the predetermined operation is performed on the operation section 44 of another POS printer 13 connected to the network 10, the POS printer 13 receives the printing job stored in the POS server 11 to execute the printing. Therefore, according to the POS system 1 of either the second embodiment or the third embodiment, it is possible to quickly recover the printing job that the POS printer 13 cannot execute.

In the above description, an example in which the POS printer 13(B) recovers the printing job that the POS printer 13(A) cannot execute is described. Of course, the printing job can be recovered by POS printers 13 rather than the POS printer 13(B). The POS printers 13 rather than the POS printer 13(B) also include, for example, the POS printer 13(A) of which the problem is eliminated by the store clerk.

Although it is the POS terminal 12 of the second embodiment and the POS printer 13 of the third embodiment that transmits the information relating to the printing job that cannot be performed to the POS server 11, it is not limited thereto. For example, when the problem of the POS printer 13 is a system error, the POS terminal 12 transmits the information relating to the printing job to the POS server 11. For example, when the sheet is jammed, the POS printer 13 may also have a function of executing a transmission processing to transmit the information relating to the printing job to the POS server 11.

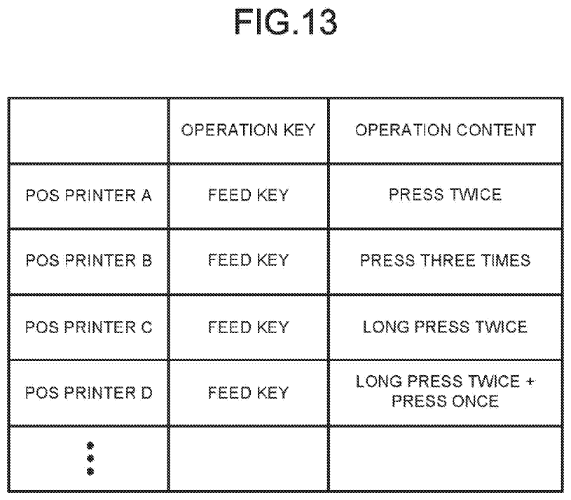

The predetermined operation set for printing recovery may be uniquely assigned to each of the plurality of POS printers 13 connected to the network 10. An example of the operation unique to each POS printer 13 is shown in FIG. 13. The POS server 11 stores information relating to the unique operation assigned to each POS printer 13 in the printer DB 31b. Specifically, the printer DB 31b includes information in which a printer number or ID, an operation switch and operation contents are associated with each other.

When the printing job that cannot be performed is transmitted from the POS printer 13 or the POS terminal 12, the POS server 11 stores the information relating to the printing job in association with information relating to a transmission source (e.g., the POS printer 13(A) or the POS terminal 12(A)). Then, when the store clerk who operates the POS terminal 12(A) presses the FEED key 44a twice in any one of the POS printers 13(B to E), the POS server 11 only transmits the information relating to the printing job transmitted from the POS printer 13(A) or the POS terminal 12(A) to which the operation of pressing the FEED key 44a twice is assigned. With such a configuration, even if the POS server 11 stores a plurality of printing jobs transmitted from different transmission sources, the store clerk who operates the POS terminal 12(A) can receive only the receipt R generated by the POS terminal 12(A) required by himself/herself.

The POS printer 13 is not limited to a thermal printer, but may be another type of printer such as an inkjet printer. Furthermore, although the POS printer 13 is described as an example of the image forming apparatus, the image forming apparatus is not limited to the printer.

The image processing system according to the embodiment is not limited to the POS system 1. The type of system is not limited as long as the system includes the information processing apparatus, the image forming apparatus and the server.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image processing system comprising a plurality of information processing apparatuses, a plurality of image forming apparatuses, and a server, all connected via a network, wherein
the sever comprises a substitute list transmission section configured to transmit a list of substitute image forming apparatuses capable of executing an image forming job to an information processing apparatus transmitting the image forming job if an image forming apparatus receiving the image forming job from the information processing apparatus cannot execute the image forming job.

2. The image forming system according to claim 1, wherein
the image processing system is a POS system, the plurality of information processing apparatuses is a plurality of POS terminals, and the plurality of image forming apparatuses is a plurality of printers.

3. The image forming system according to claim 1, wherein
the plurality of image forming apparatuses is a plurality of thermal printers.

4. The image forming system according to claim 1, wherein
the network is at least one of a wired network and wireless network.

5. An image processing system comprising a plurality of information processing apparatuses, a plurality of image forming apparatuses, and a server, all connected via a network, wherein
each information processing apparatus comprises a job transfer section configured to transfer information relating to an image forming job to the server when an image forming apparatus receiving the image forming job cannot execute the image forming job, and
each image forming apparatus comprises a job reception section configured to request the server for the information relating to the image forming job that cannot be performed and receive the information from the server when a prescribed operation is performed on an operation section of another image forming apparatus, and an image forming section configured to execute the image forming job based on the received information relating to the image forming job.

6. The image forming system according to claim 5, wherein
the image processing system is a POS system, the plurality of information processing apparatuses is a plurality of POS terminals, and the plurality of image forming apparatuses is a plurality of printers.

7. The image forming system according to claim 5, wherein
the plurality of image forming apparatuses is a plurality of thermal printers.

9. The image forming system according to claim 5, wherein
the network is at least one of a wired network and wireless network.

10. An image processing system comprising a plurality of information processing apparatuses, a plurality of image forming apparatuses, and a server, all connected via a network, wherein
each image forming apparatus comprises a job transfer section configured to transfer information relating to an image forming job received from an information processing apparatus to the server when an image forming apparatus cannot execute the image forming job, a job reception section configured to request the server for the information relating to the image forming job that cannot be performed and receive the information from the server when a prescribed operation is performed on an operation section of another image forming apparatus, and an image forming section configured to execute the image forming job based on the received information relating to the image forming job.

11. The image forming system according to claim 10, wherein
the image processing system is a POS system, the plurality of information processing apparatuses is a plurality of POS terminals, and the plurality of image forming apparatuses is a plurality of printers.

12. The image forming system according to claim 10, wherein
the plurality of image forming apparatuses is a plurality of thermal printers.

13. The image forming system according to claim 10, wherein
the network is at least one of a wired network and wireless network.

14. An image forming apparatus, comprising:
an image forming section configured to execute an image forming job;
an operation section; and
a job reception section configured to request and receive information relating to an image forming job that cannot be performed, which is stored in a server connected to the image forming apparatus via a network when a prescribed operation is performed on the operation section.

15. The image forming apparatus according to claim 14, wherein
the prescribed operation performed on the operation section is an operation of pressing a feed key for conveying a sheet on which an image is formed by a prescribed number of times and a prescribed length.

16. The image forming apparatus according to claim 14, wherein
the image forming apparatus is a printer.

17. The image forming apparatus according to claim 14, wherein
the image forming apparatus is a thermal printer.

18. The image forming apparatus according to claim 14, wherein
the image forming section comprises a thermal printing head.

19. The image forming apparatus according to claim 14, wherein
the job reception section is configured to request and receive information relating to the image forming job via a USB interface.

20. The image forming apparatus according to claim 14, wherein
the job reception section is configured to request and receive information relating to the image forming job via a wireless interface.
